(19) United States
(12) Patent Application Publication
(10) Pub. No.: US 2011/0244352 A1
(43) Pub. Date: Oct. 6, 2011

(54) FUEL CELL SYSTEM COMPRISING AN INSULATING DEVICE

(75) Inventors: Matthias Boltze, Neuendorf (DE); Michael Rozumek, Neubrandenburg (DE)

(73) Assignee: ENERDAY GMBH, Stockdorf (DE)

(21) Appl. No.: 12/305,774

(22) PCT Filed: Jun. 23, 2007
(86) PCT No.: PCT/DE2007/000928

§ 371 Date: Jul. 21, 2009

(30) Foreign Application Priority Data
Jul. 10, 2006 (DE) 10 2006 031 864.1

(51) Int. Cl. H01M 8/04

(52) U.S. Cl. 429/433

(57) ABSTRACT

The invention relates to a fuel cell system comprising an insulation means for thermally insulating a first portion from a second portion, the first portion during operation of the fuel cell system generally being at a higher temperature level than the second portion and the insulation means comprising at least one leadthrough portion interfacing the first portion and second portion through which at least one component of the fuel cell system is led during operation of the fuel cell system in thus coming into thermal contact with the first portion and the second portion. In accordance with the invention it is provided for that at least part of the component is made of a material featuring a lower thermal conductivity than that of adjacent parts resulting in an insulation part and that the insulation part is sited at least partly within the leadthrough portion.

The invention relates to a fuel cell system comprising an insulation means for thermally insulating a first portion from a second portion, the first portion during operation of the fuel cell system generally being at a higher temperature level than the second portion and the insulation means comprising at least one leadthrough portion interfacing the first portion and second portion through which at least one component of the fuel cell system is led during operation of the fuel cell system in thus coming into thermal contact with the first portion and the second portion.

Fuel cell systems serve to generate electrical energy and thermal energy, it being the primary feed of fossil fuels that is increasingly gaining significance. In the mobile sector, i.e. particularly in motor vehicles preference is given to using the fuels as normal for motor vehicles whilst in the non-mobile sector, i.e. particularly in domestic applications, natural gas and fuel oil are used.

Needed to process these fuels is a reforming process which, at least partly, is strongly exothermic. Likewise finding application are afterburners capable of converting the exhaust gases of the fuel cell or also the primary feed fuel in exothermic reactions. The waste heat generated by the fuel cells themselves in the fuel cell system which, particularly in the case of the solid oxide fuel cell (SOFC), can be quite considerable, need to be taken into account. Thus temperatures ranging from 500 to 1000° C. are involved in the fuel cell system depending on the operating condition and design.

Reducing the heat losses due to heat transfer to the environment of the fuel cell system is a prime requirement and for this purpose high-performance insulation means are used which, however, need to feature leadthrough portions, for example for the purpose of fuel feed, air feed or exhaust gas discharge. Since because of the high temperatures materializing these components are often made of high-temperature metals which are simultaneously good heat conductors, heat bridges bridge the leadthrough portions of the high-performance insulation means associated with high heat losses from the high-temperature portion to the environment. Similar problems are met with when various portions within the fuel cell system need to be thermally insulated from each other, the interface of which then featuring an excessive heat transfer.

It is particularly because of this discharge of heat to the environment that system efficiency is reduced, resulting in components located outside of the high-temperature portion being thermally overloaded. A further disadvantage is the rapid cooling of the system on shutdown, resulting in the time needed for starting being significantly extended when the system is returned ON.

The invention is based on the object of avoiding unwanted heat transfers in a fuel cell system.

This object is achieved by the features of the independent claim.

Advantageous embodiments of the invention read from the dependent claims.

The invention is based on the generic fuel cell system in that at least part of the component is made of a material featuring a lower thermal conductivity than that of adjacent parts resulting in an insulation part and that the insulation part is sited at least partly within the leadthrough portion. When the component is, for instance, an exhaust pipe, part of the exhaust pipe is made of a poor heat conductor whilst adjacent parts of the pipe are made of a heat-resisting metal conventionally. The thus resulting insulation part of the exhaust pipe is disposed at least partly within the leadthrough portion so that the metal pipe part sited in the first portion cannot enter into thermal conductivity with the second portion just as little as the metal pipe part sited in the second portion cannot come into thermal conductivity with the first portion. This principle as illustrated by way of the exhaust pipe as an example applies to all and any components led through the insulation part, for example fuel feeders, oxidant feeders, burner tubes, flame tubes, reformer tubes, etc.

The invention can be expediently configured so that the insulation part is fully sited within the leadthrough portion. Even though for the basic success of the present invention it is only essential that the insulation part partly overlaps the leadthrough portion, siting the insulation part fully within the leadthrough portion is a preferred achievement.

It may be provided for that the insulation part comprises a reflective surface facing the first portion in the insulation part thus serving not only to prevent heat conduction between the two portions but also to reduce radiation losses by the reflective surface. The reflective coating may be vapor deposited for example on the insulation part.

As regards further functioning it is provided for that the insulation part comprises connecting means for connecting adjacent parts. For example, the insulation part may feature female threads into which adjacent component parts machined with a male thread can be screwed. Likewise possible are twist locks or similar mechanical couplings.

In another embodiment of the present invention it is provided for that the insulation part is a component of the insulation means, as a result of which the insulation means serves as a means for coupling various modules. The insulation means can be prefitted with the insulation parts of the various modules so that they can be simply attached to the insulation part, for example, by screwing them into place.

In accordance with a particularly preferred embodiment it is provided for that the insulation part is made of a ceramic material.

The invention will now be detailed by way of particularly preferred embodiments with reference to the attached drawings in which:

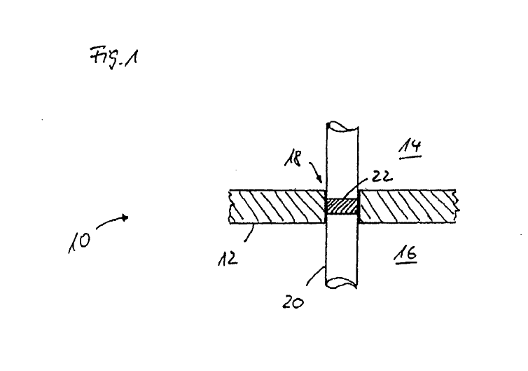

FIG. 1 is a partly sectioned view of part of a first embodiment of a fuel cell system in accordance with the invention;

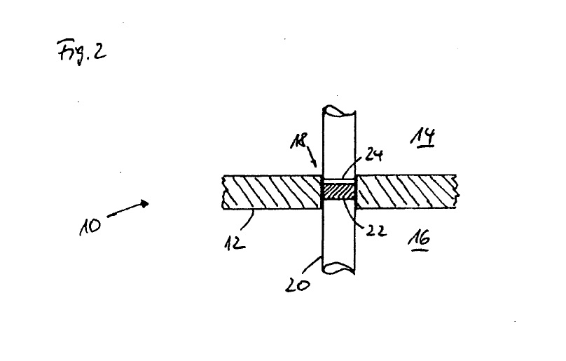

FIG. 2 is a partly sectioned view of part of a second embodiment of a fuel cell system in accordance with the invention;

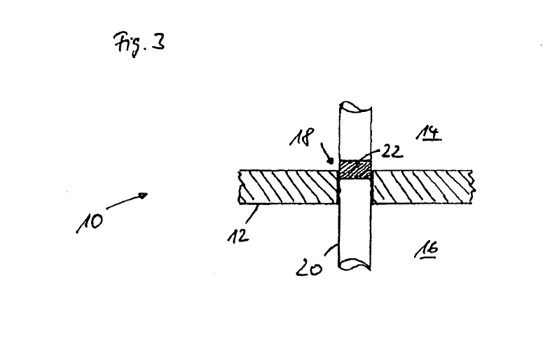

FIG. 3 is a partly sectioned view of part of a third embodiment of a fuel cell system in accordance with the invention;

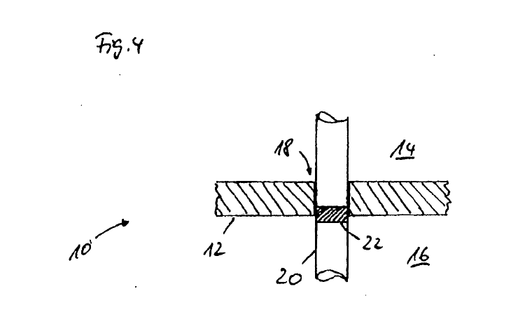

FIG. 4 is a partly sectioned view of part of a fourth embodiment of a fuel cell system in accordance with the invention;

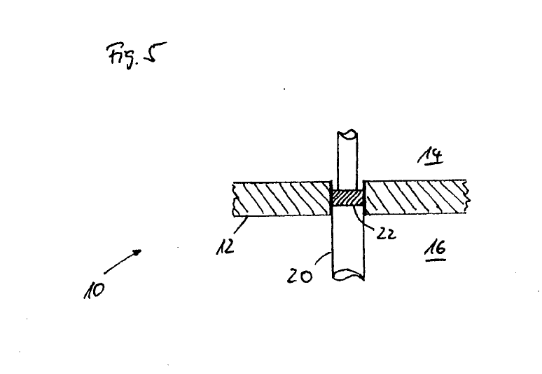

FIG. 5 is a partly sectioned view of part of a fifth embodiment of a fuel cell system in accordance with the invention;

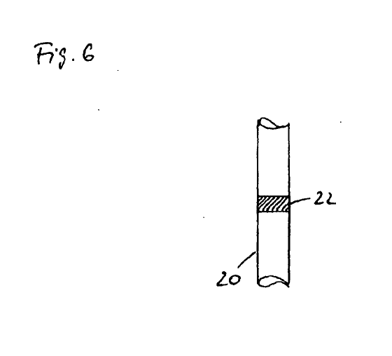

FIG. 6 is a view of a component including an insulation part to be led through an insulation means; and

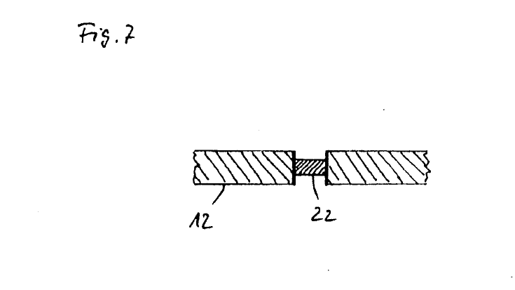

FIG. 7 is a view of an insulation means including an insulation part in the leadthrough portion.

The reference numerals in the following description of the FIGs in the drawings identify components which are the same or comparable.

Referring now to FIG. 1 there is illustrated a partly sectioned view of part of a first embodiment of a fuel cell system in accordance with the invention. The fuel cell system 10 as shown in part comprises a high-temperature portion 14 and a low-temperature portion 16, the low-temperature portion 16 being for example the environment of the fuel cell system 10, although it is just as possible that the portions 14, 16 are both sited within the fuel cell system 10 but expediently maintained at different temperature levels. The portions 14, 16 are separated from each other by an insulation means 12, the insulation means 12 comprising a leadthrough portion 18 through which a component 20 of the fuel cell system 10, for instance an exhaust pipe is led through. To prevent thermal conductivity from the portion 14 into the portion 16 a part of the component 20 is configured as an insulation part 22. For example, the insulation part 22 is made of a ceramic material whilst the remainder of the component 20 is made of metal having high temperature resistance. In addition to serving as an insulation the insulation part 22 may also serve as a connecting element by being equipped with connecting means. For instance, the insulation part 22 has a female thread into which the male thread is screwed for connecting these parts thereto.

Referring now to FIG. 2 there is illustrated a partly sectioned view of part of a second embodiment of a fuel cell system in accordance with the invention. Here, in addition to the embodiment as shown in FIG. 1, a reflective surface 24 is provided in the region of the insulation parts, which reduces the radiation losses from the first portion 14 into the second portion 16.

Referring now to FIG. 3 there is illustrated a partly sectioned view of part of a third embodiment of a fuel cell system in accordance with the invention in which the insulation part 22 partly overlaps the high-temperature portion 14. Unlike the embodiment as shown in FIG. 1 the insulation part 22 in this case is not fully sited within the leadthrough portion 18. However, here too the formation of a heat bridge is avoided in this way.

Referring now to FIG. 4 there is illustrated a partly sectioned view of part of a fourth embodiment of a fuel cell system in accordance with the invention. In accordance with this embodiment the insulation part partly overlaps the low-temperature portion 16, but here too the formation of a hot bridge between the high-temperature portion 14 and portion 16 is avoided by this arrangement.

Referring now to FIG. 5 there is illustrated a partly sectioned view of part of a fifth embodiment of a fuel cell system in accordance with the invention. In this embodiment the component 20 to be led through the leadthrough portion 18 features different dimensions on the two opposite sides of the insulation part 22. This example aspect makes it clear that the present invention can be put to use in many variants, it also illustrating that the insulation part is not just suitable for meeting the task of an insulation or connection but is also suitable to make a certain adapter functionality available.

Referring now to FIG. 6 there is illustrated a view of a component including an insulation part to be led through an insulation means. In this example the insulation part 22 together with the adjacent parts of the component 20 can be handled independently of the others.

Referring now to FIG. 7 there is illustrated a view of an insulation means including an insulation part in the leadthrough portion. In this example aspect as shown, the insulation part 22 is fixedly connected to the insulation means 12 so that—particularly when the insulation part 22 comprises connecting means—the insulation means 12 makes a means for mounting the individual modules of the fuel cell system available.

It is understood that the features of the invention as disclosed in the above description, in the drawings and as claimed may be essential to achieving the invention both by themselves or in any combination.

### LIST OF REFERENCE NUMERALS

10 fuel cell system
12 insulation means
14 first portion
16 second portion
18 leadthrough portion
20 component
22 insulation part
24 reflective surface

1. A fuel cell system comprising an insulation means for thermally insulating a first portion from a second portion, the first portion during operation of the fuel cell system generally being at a higher temperature level than the second portion and the insulation means comprising at least one leadthrough portion interfacing the first portion and second portion through which at least one component of the fuel cell system is led during operation of the fuel cell system in thus coming into thermal contact with the first portion and the second portion characterized in that at least part of the component is made of a material featuring a lower thermal conductivity than that of adjacent parts, resulting in an insulation part and that the insulation part is sited at least partly within the leadthrough portion.

2. The fuel cell system of claim 1, wherein the insulation part is fully sited within the leadthrough portion.

3. The fuel cell system of claim 1, wherein the insulation part comprises a reflective surface facing the first portion.

4. The fuel cell system of claim 1, wherein the insulation part comprises connecting means for connecting adjacent parts.

5. The fuel cell system of claim 1, wherein the insulation part is a component of the insulation means.

6. The fuel cell system of claim 1, wherein the insulation part is made of a ceramic material.
